(19) United States
(12) Patent Application Publication
(10) Pub. No.: US 2022/0108357 A1
(43) Pub. Date: Apr. 7, 2022

(54) RETAIL INTELLIGENT DISPLAY SYSTEM AND ELECTRONIC DISPLAYS THEREOF

(71) Applicants: KEYONG LU, Diamond Bar, CA (US); YAJUN ZHANG, San Jose, CA (US); CHUN NAN KUO, New Taipei City (TW)

(72) Inventors: KEYONG LU, Diamond Bar, CA (US); YAJUN ZHANG, San Jose, CA (US); CHUN NAN KUO, New Taipei City (TW)

(21) Appl. No.: 17/478,496

(22) Filed: Sep. 17, 2021

Related U.S. Application Data
(60) Provisional application No. 63/086,338, filed on Oct. 1, 2020.
(60) Provisional application No. 63/086,347, filed on Oct. 1, 2020.

(51) Int. Cl. G06Q 30/02; G06Q 10/08; G06F 1/3234; G06F 1/3231; G06F 3/0488; G09F 3/20

(52) U.S. Cl. CPC G06Q 30/0281; G06Q 30/0201; G06Q 30/0272; G06Q 10/087; G09F 3/208; G06F 1/3265; G06F 1/3231; G06F 3/04883; G06Q 30/0212

(57) ABSTRACT

A retail intelligent display system may include at least one fixture configured for placing at least one article of merchandise thereon, at least one electronic display coupled to the at least one fixture, and a network device. The network device may include a communication module communicatively coupled to the at least one electronic display, a processor communicatively coupled to the communication module and the at least one electronic display, and a non-transitory machine-readable memory storing instructions. The retail intelligent display system may compare pricing information of the at least one article of merchandise with pricing information from one or more competitor sources, update the pricing information of the merchandise based on the pricing information from the competitor sources, and display at least one of the updated pricing information and other comparable pricing information of the merchandise on the electronic display.

### CROSS-REFERENCE TO RELATED APPLICATIONS

The present application claims priority benefit of U.S. Provisional Application No. 63/086,338, filed on Oct. 1, 2020, and U.S. Provisional Application No. 63/086,347, filed on Oct. 1, 2020, which is hereby incorporated by reference in its entirety.

### FIELD

The present disclosure generally relates to an intelligent display system including a plurality of electronic displays for displaying information regarding articles of merchandise in a retail environment. In particular, the present disclosure seeks to improve retail management, customer experience, and marketing/promotional/advertising content dissemination with the intelligent display system and the electronic displays thereof.

### BACKGROUND

Nonreusable-medium displays (e.g., paper or plastic price tags) have been prevalently and traditionally used for merchandise pricing in a retail environment (e.g., a brick and mortar store, a warehouse-type wholesale store, etc.). The traditional paper or plastic based price tags may have low initial investment costs. However, the pricing tag has various limitations that cannot be overlooked. For example, paper or plastic price tags are inefficient in displaying pricing information due to frequent tag replacements from high fluctuation in pricing or simply because a tag was missing or has a wrong price. Such inefficiencies are not environmentally friendly due to the tag's nonreusable nature. Other limitations of a paper or plastic price tag may include its inability to dynamically display the most current pricing, and the tag's inability to provide more information associated with any merchandise besides pricing due to its limited surface area. Overall, the displaying pricing information using traditional price tags in a retail environment is inefficient. On the other hand, as electronic displays lower in cost per unit while being smaller in size, electronic displays are becoming more prevalently applicable in many different industries, such as vehicle dashboards, home security, retail environment, etc. The potential market of utilizing electronic displays in a retail environment may be enormous, and may provide a more efficient way to manage retail merchandise, customer experience, and marketing/promotional/advertising content dissemination to differentiate the store experience for the customers/shoppers, store management, and retail staff.

### SUMMARY

The present disclosure generally relates to an intelligent display system including a plurality of electronic displays for displaying pricing and other information related to at least one article of merchandise.

In accordance with one aspect of the present disclosure, a retail intelligent display system may include at least one fixture, the at least one fixture may be configured for placing at least one article of merchandise thereon, at least one electronic display may be coupled to the at least one fixture and a network device. The network device may include a communication module communicatively coupled to the at least one electronic display, a processor communicatively coupled to the communication module and the at least one electronic display, and a non-transitory machine-readable memory storing instructions that, when executed by the processor, cause the retail intelligent display system to compare pricing information of the at least one article of merchandise with pricing information from one or more competitor sources, update the pricing information of the at least one article of merchandise based on the pricing information from the one or more competitor sources, and display at least one of the updated pricing information and other comparable pricing information of the at least one article of merchandise on the at least one electronic display.

In some implementations, the non-transitory machine-readable memory may store additional instructions that, when executed by the processor, cause the retail intelligent display system to request a managerial approval before updating and displaying the updated pricing information, or update price information automatically based on predefined rules and policies stored at the system.

In some implementations, the one or more competitor sources may include e-commerce competitors.

In some implementations, the non-transitory machine-readable memory may store additional instructions that, when executed by the processor, cause the retail intelligent display system to display customer review information of the at least one article of merchandise on the at least one electronic display.

In some implementations, the non-transitory machine-readable memory may store additional instructions that, when executed by the processor, cause the retail intelligent display system to perform at least one of: displaying, on the at least one electronic display, at least one of: marketing content related to the at least one article of merchandise; marketing content of other merchandise; advertising content related to the at least one article of merchandise; advertising content of other merchandise; promotional content related to the at least one article of merchandise; and promotional content of other merchandise; storing information of a number of times and time length that the at least one of the marketing content, the promotional content, and the advertising content is displayed on the at least one electronic display; and providing the information to a marking, promotional or advertising entity associated with the at least one of the marketing content, the promotional content, and the advertising content.

In some implementations, the at least one electronic display may be an interactive display that allows a shopper to interact with content regarding the at least one article of merchandise and displaying on the at least one electronic display.

In some implementations, the interactive display may include at least one of one or more touch sensors, gesture sensors, and microphones.

In some implementations, the non-transitory machine-readable memory may store additional instructions that, when executed by the processor, cause the retail intelligent display system to perform at least one of: displaying at least one of: inventory information of the at least one article of merchandise on the at least one electronic display; kitting information; cross sale information for related merchandise; a user manual of the at least one article of merchandise on the at least one electronic display; and an announcement message on the at least one electronic display; providing geolocation information of the at least one article of merchandise on a wireless communication device of a shopper to assist the shopper to locate the at least one article of merchandise; enabling Online to Offline (020) campaigns including one or more in-store lottery or treasure hunts; and providing a visual signal to a shopper using the at least one electronic display to alert the shopper of a location of the at least one article of merchandise.

In some implementations, the network device may be communicatively coupled to a retail intelligent monitoring system for monitoring the at least one article of merchandise on the at least one fixture and the network device may be configured to cause the at least one electronic display to display an out of stock message and at least one alternative source for purchasing the at least one article of merchandise.

In some implementations, the network device may be communicatively coupled to a retail intelligent monitoring system for monitoring the at least one article of merchandise on the at least one fixture and the at least one electronic display may enter a power saving mode after a predetermined time period or when the retail intelligent monitoring system detects no customer activity or presence or out-of-store hours.

In some implementations, the network device may be coupled to a backend device.

In accordance with another aspect of the present disclosure, a method for a retail intelligent display system may include at least one electronic display that is installed on at least one fixture. The method may include comparing pricing information of at least one article of merchandise on the at least one fixture with pricing information from one or more competitor sources, updating the pricing information of the at least one article of merchandise based on the pricing information from the one or more competitor sources, and displaying at least one of the updated pricing information and other comparable pricing information of the at least one article of merchandise on the at least one electronic display.

In some implementations, the method may further include requesting a managerial approval before updating and displaying the updated pricing information, or update price information automatically based on predefined rules and policies stored at the system.

In some implementations, the one or more competitor sources include e-commerce competitors.

In some implementations, the method may further include displaying customer review information of the at least one article of merchandise on the at least one electronic display.

In some implementations, the method may further include displaying, on the at least one electronic display, at least one of: marketing content related to the at least one article of merchandise; marketing content of other merchandise; advertising content related to the at least one article of merchandise; advertising content of other merchandise; promotional content related to the at least one article of merchandise; and promotional content of other merchandise; storing information of a number of times and time length that the at least one of the marketing content, the promotional content, and the advertising content is displayed on the at least one electronic display; and providing the information to a marking, promotional or advertising entity associated with the at least one of the marketing content, the promotional content, and the advertising content.

In some implementations, the method may further include receiving an input from a shopper through the at least one electronic display and displaying content based on the input from the shopper on the at least one electronic display.

In some implementations, the at least one electronic display may include at least one of one or more touch sensors, gesture sensors, and microphones.

In some implementations, the method may further include performing at least one of: displaying at least one of: inventory information of the at least one article of merchandise on the at least one electronic display; kitting information; cross sale information for related merchandise; an out of stock message and at least one alternative source for purchasing the at least one article of merchandise; a user manual of the at least one article of merchandise on the at least one electronic display; and an announcement message on the at least one electronic display; providing geolocation information of the at least one article of merchandise on a wireless communication device of a shopper to assist the shopper to locate the at least one article of merchandise; enabling Online to Offline (020) campaigns including one or more in-store lottery or treasure hunts; and providing a visual signal to a shopper using the at least one electronic display to alert the shopper of a location of the at least one article of merchandise.

In some implementations, the method may further include entering a power saving mode by the at least one electronic display after a predetermined time period or when no customer activity or presence of a customer nearby is detected or out-of-store hours.

### BRIEF DESCRIPTION OF DRAWINGS

Aspects of the present disclosure are best understood from the following detailed description when read with the accompanying figures. Various features are not drawn to scale. Dimensions of various features may be arbitrarily increased or reduced for clarity of discussion.

FIG. 1 is a schematic diagram of an example retail intelligent display system in accordance with an implementation of the present disclosure.

FIG. 2 is a schematic diagram of a plurality of electronic displays of an example retail intelligent display system in accordance with an implementation of the present disclosure.

FIG. 3 is a schematic diagram of an example retail intelligent display system in accordance with an implementation of the present disclosure.

FIG. 4 is a schematic diagram illustrating a traditional price display system and an example retail intelligent display system in accordance with an implementation of the present disclosure.

FIG. 5 is a schematic diagram further illustrating the example retail intelligent display system of the present disclosure in FIG. 4.

FIG. 6 is a schematic diagram of a plurality of displayable contents displayed on an electronic display of an example retail intelligent display system in a retail environment in accordance with an implementation of the present disclosure.

FIG. 7 is a schematic diagram further illustrating the example retail intelligent display system of the present disclosure in FIG. 6.

FIG. 8 is a flowchart diagram illustrating an example method performed by a retail intelligent display system in accordance with example implementations of the present disclosure.

FIG. 9 is a flowchart diagram further illustrating an example implementation of the method of the retail intelligent display system in FIG. 8.

FIG. 10 is a flowchart diagram further illustrating an example implementation of the method of the retail intelligent display system in FIG. 8.

FIG. 11 is a flowchart diagram further illustrating an example implementation of the method of the retail intelligent display system in FIG. 8.

FIG. 12 is a flowchart diagram further illustrating an example implementation of the method of the retail intelligent display system in FIG. 8.

FIG. 13 is a flowchart diagram further illustrating an example implementation of the method of the retail intelligent display system in FIG. 8.

FIG. 14 is a flowchart diagram further illustrating an example implementation of the method of the retail intelligent display system in FIG. 8.

### DESCRIPTION

The following disclosure contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art.

Unless noted otherwise, like or corresponding elements among the figures may be indicated by like or corresponding reference numerals. Moreover, the drawings and illustrations in the present disclosure are generally not to scale, and are not intended to correspond to actual relative dimensions.

For the purposes of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in some implementations,” or “in some implementations,” which may each refer to one or more of the same or different implementations. The term “comprising” means “including, but not necessarily limited to” and specifically indicates open-ended inclusion or membership in the so-described combination, group, series, and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

In one or more implementations of the present disclosure, the retail intelligent display system aims to leverage the advantages of electronic displays, for example, more efficiently display pricing of at least one article of merchandise on an electronic display than a traditional paper or plastic based price tag, to improve the overall efficiency of retail management, customer experience, and marketing/promotional/advertising content dissemination by providing dynamic and updated information (e.g., pricing information, background, promotional content, advertising content, marketing content, reviews, coupons, inventory information, color selection, instruction manuals, kitting information, cross sale information, etc.) in connection with at least one article of merchandise in at least one store, on at least one electronic display coupled to at least one store fixture (e.g., rack, shelf, deck, level, hook, wire basket, display case, table, hanger, panel, etc.). The at least one store fixture may be designed to be compatible with existing shelf systems (e.g., gondola shelf system, etc.). The retail intelligent display system of the present disclosure may be compatible with the existing store fixture systems in a store to reduce costs, implementation time and to maximize profit (e.g., return on investments ROI, etc.). In some implementations, the at least one fixture and the at least one electronic display may be two individual components coupled to one another. In some implementations, the at least one fixture may be integrated with the at least one electronic display as a single electronic device, but configurations of the fixture and the electronic display are not limited to the example configurations provided herein.

The retail intelligent display system in the present disclosure may further include a network device having a communication module communicatively coupled to the at least one electronic display in the at least one store, a processor (e.g., a central processing unit in a terminal device, a local server, a backend server, etc.) communicatively coupled to the communication module and the at least one electronic display, and a non-transitory machine-readable memory storing instructions that, when executed by the processor, cause the retail intelligent display system to perform one or more price management operations.

The price management operations, in some implementations, may include comparing the pricing information of the at least one article of merchandise with pricing information from one or more competitor sources (e.g., e-commerce competitors, etc.), updating the pricing information of the at least one article of merchandise based on the pricing information from one or more competitor sources, displaying at least one of the updated pricing information and other comparable pricing information of the at least one article of merchandise on the at least one electronic display in the at least one store, etc.

In one or more implementations, the electronic display of the retail intelligent display system in the present disclosure may further provide marketing/promotional/advertising content to shoppers/customers to enhance shoppers/customers experience as well to marketing/promotional/advertising research entities to enhance future shoppers/customers experience.

In one or more implementations, the retail intelligent display system in the present disclosure may be communicatively coupled to a retail intelligent monitoring system for monitoring at least one article of merchandise on at least one store fixture, and the electronic display may display inventory information regarding the at least one article of merchandise and at least one alternative source for purchasing the at least one article of merchandise.

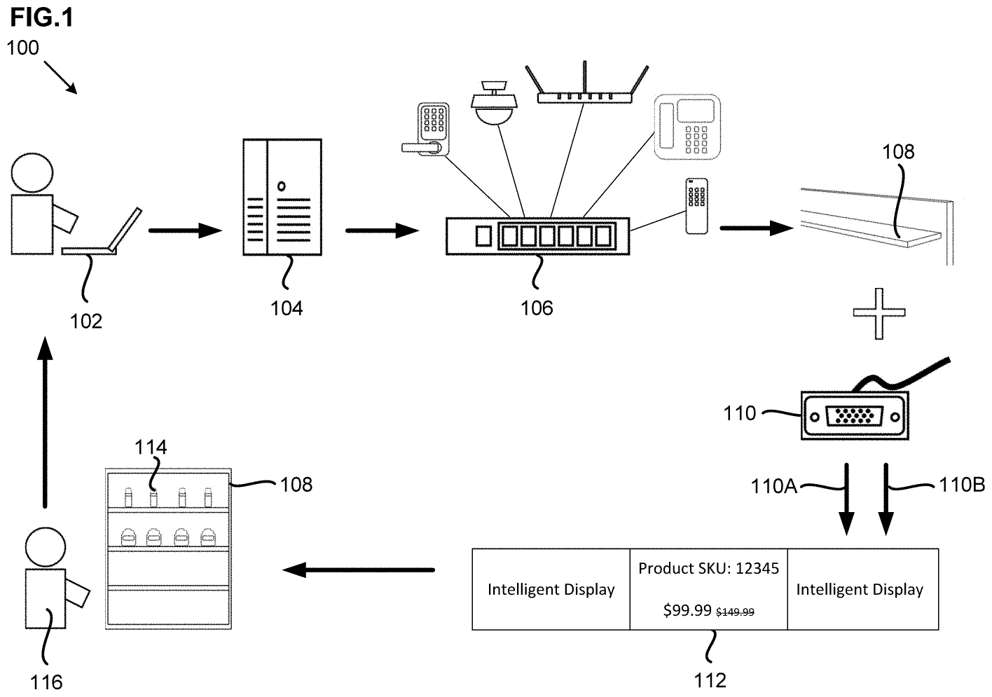

FIG. 1 is a schematic diagram of an example retail intelligent display system 100 in accordance with an implementation of the present disclosure. In one or more implementations of the present disclosure, the example retail intelligent display system 100 in FIG. 1 may include a terminal device 102, a network device 104, a routing device (e.g., including an ethernet connection slot, etc.) 106, at least one store fixture 108 on which at least one article of merchandise 114 (e.g., a product, etc.) is disposed, at least one electronic display 112 coupled to the at least one store fixture 108, a data and/or power connector (e.g., base connector) 110 coupled to the at least one store fixture 108 and/or the at least one electronic display 112 to provide power 110A and means for data communication 110B between the at least one electronic display 112, the network device 104, and the terminal device 102, such that a processor (not explicitly shown) of the terminal device 102 or the network device 104 may perform different price management operations.

As described above, the price management operations may include, but are not limited to, comparing pricing information of the at least one article of merchandise 114 with pricing information from one or more competitor sources, updating the pricing information of the at least one article of merchandise 114 based on the pricing information from the one or more competitor sources, displaying at least one of the updated pricing information and other comparable pricing information of the at least one article of merchandise 114 on the at least one electronic display 112 in the at least one store, etc. In one or more implementations, the data and/or power connector 110 may include a chip-on-flex (COF) to process video and image rendering based on the pricing information.

In one or more implementations of the present disclosure, the example structure of the retail intelligent display system 100 in FIG. 1 may include the terminal device 102, for example operated by an operator (store manager, a corporate user, a merchandiser in headquarter etc.), that communicates with the network device 104 and the routing device 106 via one or more networks (e.g., a local network, a public network, such as the internet, etc.). The terminal device 102 may further communicate and control the at least one electronic display 112 via the data and/or power connector 110 such that the at least one electronic display 112 coupled to the at least one store fixture 108 may display at least one of the updated pricing information and other comparable pricing information of the at least one article of merchandise 114 to customers (e.g., patrons) and/or shoppers (e.g., without completing transaction, etc.) 116 in the at least one store.

In some implementations, the terminal device 102 may include, for example, a non-transitory machine-readable memory for storing the at least one of the updated pricing information and other comparable pricing information associated with the merchandise 114 and a computer, a laptop, or a tablet, each having a processor (e.g., CPU, etc.) to process the at least one of the updated pricing information and other comparable pricing information associated with the merchandise 114 such that the at least one of the updated pricing information and other comparable pricing information associated with the merchandise 114 may be displayed on the electronic display 112, but the components of the terminal device 102 may not be limited to the examples provided herein.

In some implementations, the network device 104 may include, for example, a local/remote server, or a backend device, each having a processor (e.g. CPU, etc.) to process and a non-transitory machine-readable memory to store the at least one of the updated pricing information and other comparable pricing information associated with the merchandise 114 to be displayed on the electronic display 112, but components of the network device 104 may not be limited to the examples provided herein.

In some implementations, the network device 104 may include a communication module (not shown, e.g., transceiver, etc.) that is communicatively coupled between the terminal device 102, the network device 104, and the at least one electronic display 112 such that at least one of the updated pricing information and other comparable pricing information of the at least one article of merchandise 114 may be displayed on the at least one electronic display 112 to customers/shoppers in the at least one store.

In some implementations, the data and/or power connector 110 (e.g., base connector, etc.) may perform all video/image rendering of the visual data to be displayed on the electronic display 112. In one or more implementation, the electronic display 112 may be a display having high resolution, wide viewing angle, easily attachable to and detachable from a store fixture, and enable plug and play data communication with the terminal device 102 and the network device 104. In some implementations, the electronic display 112 may be vandal proof, scratch resistant, and may only be removed by special designed tools. In some implementations, some electronic displays 112 may be easily attachable to, and detachable from, a store fixture.

As such, retail management, customer experience, and marketing/promotional/advertising content dissemination in a retail environment may be improved with the retail intelligent display system 100.

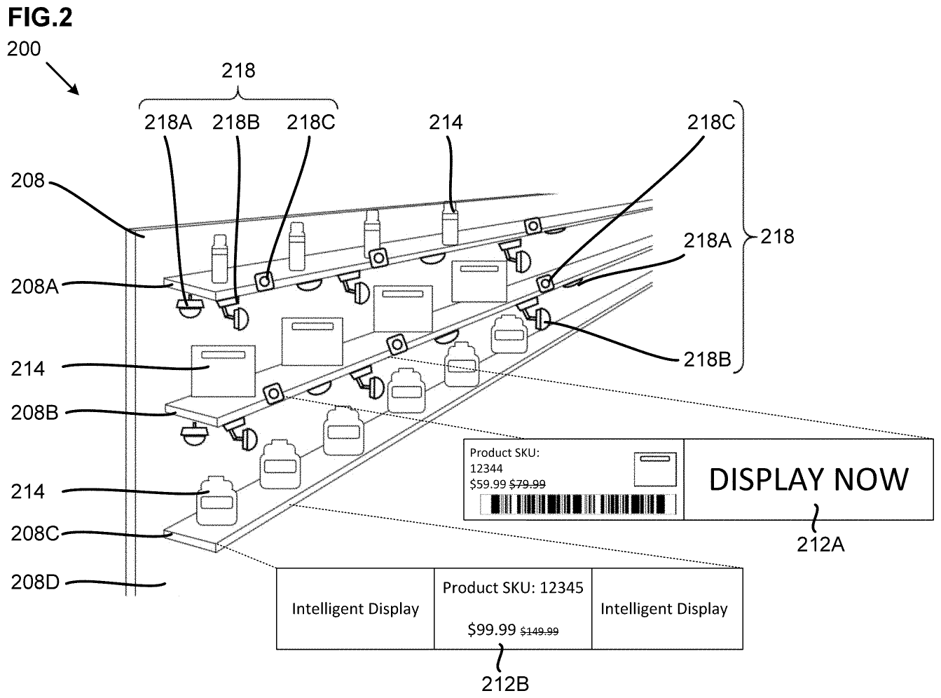

FIG. 2 is a schematic diagram of a plurality of electronic displays of an example retail intelligent display system 200 in accordance with an implementation of the present disclosure. In one or more implementations of the present disclosure, the example retail intelligent display system 200 may include a plurality of electronic displays coupled to a plurality of store fixtures (e.g., racks, shelves, decks, levels, hooks, wire baskets, display case, tables, hangers, panels, etc.). In one or more implementations of the present disclosure, the example retail intelligent display system 200 may include at least a first electronic display 212A and second electronic display 212B respectively coupled to a plurality of store fixtures which may include a rack 208 and a plurality of shelves (e.g., 208A, 208B, 208C, 208D, etc.) coupled to the rack 208. The first electronic display 212A and the second electronic display 212B in FIG. 2 may be similar to the at least one electronic display 112 in FIG. 1.

In one or more implementation, the first electronic display 212A may be coupled to a surface of a second shelf 208B of the rack 208 to display at least one of the updated pricing information (e.g., current pricing set by the store, etc.) and other comparable pricing information (e.g., current pricing at other competitor sources, etc.) of the at least one article of merchandise 214 to customers/shoppers in the at least one store.

In some implementations, the first electronic display 212A may be coupled to a front panel of the second shelf 208B to display updated pricing information of the merchandise 214 on the second shelf 208B to customers/shoppers in the store as shown in FIG. 2. In some implementations, the second electronic display 212B may be coupled to a front panel of a fourth shelf 208D of the rack 208 to display at least one of the updated pricing information and other comparable pricing information of the at least one article of merchandise 214 to customers/shoppers in the store.

In some implementations not explicitly shown, the first electronic display 212A may be coupled to a side surface of the second shelf 208B to display updated pricing information and other comparable pricing information of the merchandise 214 to customers/shoppers located at the side of the second shelf 208B where the customers/shoppers are located. In one or more implementations, the electronic displays 212A, 212B, and the plurality of shelves 208A, 208B, 208C, 208D in the example retail intelligent display system 200 of FIG. 2 may substantially be the same as the least one electronic display 112 and the at least one store fixture 108 in FIG. 2. In one or more implementations, the example retail intelligent display system 200 may include but not explicitly shown a network device, a routing device, and a data and/or power connector similar to the network device 104, the routing device 106, and the data and/or power connector 110 in FIG. 1, respectively. In one or more implementations, the electronic displays 212A, 212B may be high definition (HD) displays, such as FHD, 4K, but may not be limited to the examples provided herein.

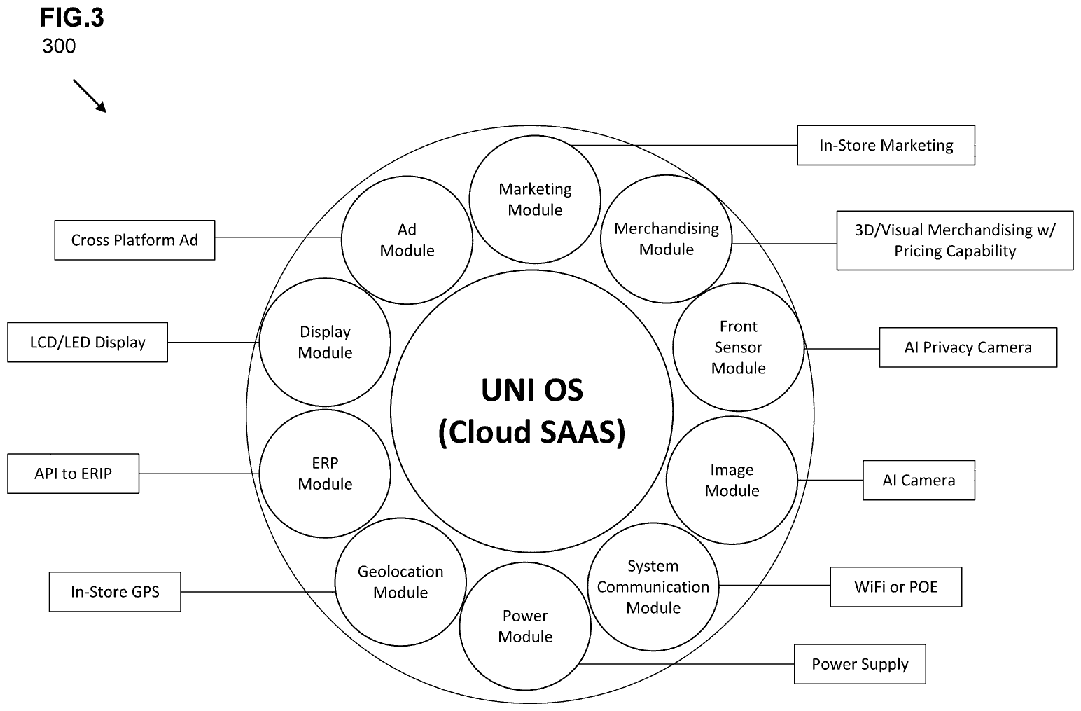

FIG. 3 is a schematic diagram of an example retail intelligent display system 300 in accordance with an implementation of the present disclosure. In one or more implementations, the example retail intelligent display system 300 may include an operating system (e.g., UNI OS in FIG. 3) having a plurality of modules in data communication with one another. The operating system may be located in a local server or a backend server over the internet (e.g., cloud-based, Software as a service SAAS etc.). The plurality of modules may include hardware and software components. The hardware components may be at least one of displays, cameras, global positioning systems, power supplies, routers, switches, splitters, processors, circuitry, servers or other processors providing cloud services, etc., and software components may be at least one of programs stored in non-transitory machine-readable memory and instructions in the programs that may be processed by a processor or circuitry.

In FIG. 3, the plurality of modules may include hardware components such as a display module (e.g., a LCD/LED display, OLED display, other high definition display, etc.), a geolocation module (e.g., global positioning system, etc.), a power module (e.g., power supply, etc.), a system communication module (e.g., WI-FI providing power over ethernet switches, routers, splitters, hubs, etc.), an image module (e.g., cameras, artificial-intelligence (AI) controlled cameras, high definition cameras, etc.), and a front sensor module (e.g., an AI privacy camera that protect identities of individuals, etc.). The plurality of modules may also include software components such as an advertising (Ad) module (e.g., a program providing cross platform advertising content, etc.), an ERP module (e.g., a program including an application program interface API to an enterprise resource planning ERP, etc.), a merchandising module (e.g., a program providing 3-dimensional (3D) or visual merchandising with pricing capability, etc.), and a marketing module (e.g., a program providing in-store marketing, etc.). In one or more implementations, the plurality of modules above in the example retail intelligent display system 300 may be in data communication with one another, which may facilitate comparisons of pricing information of at least one article of merchandise with pricing information from one or more competitor sources, updates of the pricing information of the at least one article of merchandise based on the pricing information from the one or more competitor sources, and display of at least one of the updated pricing information and other comparable pricing information of the at least one article of merchandise on at least one electronic display in at least one store.

In some implementations, the example retail intelligent display system 300 may include the Ad module, the display module, the ERP module, the geolocation module, the power module, the communication module, the merchandising module, and the marketing module interconnected to one another to facilitate comparisons of pricing information of at least one article of merchandise with pricing information from one or more competitor sources, updates of the pricing information of the at least one article of merchandise based on the pricing information from the one or more competitor sources, and displaying of at least one of the updated pricing information and other comparable pricing information of the at least one article of merchandise on at least one electronic display in at least one store.

In one or more implementations, the display module of the example retail intelligent display system 300 may include the electronic display 112 in FIG. 1 and the electronic displays 212A, 212B in FIG. 2. In one or more implementations, the display module of the example retail intelligent display system 300 may have a size of about 2″ in width and 12″ to 60″ in length, and a resolution of from about 167×1002 pixels to 167×5010 pixels. In some implementations, the size and the resolution of the display module may be 2″×12″ at 167×1002 pixels, 2″×24″ at 167×2004 pixels, 2″×36″ at 167×3006 pixels, 2″×4″ to 2″×8″ at 167×4008 pixels, or 2″×60″ at 167×5010 pixels. In some implementations, the display module may have standard connectors to connect to a base of a store fixture to provide power and means for data communication. In some implementations, the display module may include daisy chain connector as long as power supply is sufficient. In some implementations, the display module may have a controller similar to existing video wall controller but with many more channels. In some implementations, the channels may be one of 8 Channels, 16 Channels, 32 Channels, 64 Channels, 96 Channels, and 128 Channels.

In one or more implementations, the power module of the example retail intelligent display system 300 may include the data and/or power connector 110 in FIG. 1 that provides power and means for data communication between the at least one electronic display 112, the network device 104, and the terminal device 102. In one or more implementations, the power module of the example retail intelligent display system 300 may include power over ethernet (POE) as the main power supply system. The POE may provide a maximum power of 100 W. The POE may utilize a mature and widely used standard/protocol or a newly developed POE standard/protocol. In one or more implementations, the communication module of the example retail intelligent display system 300 may use POE as the communication channel and share the same line as the power supply. In some implementations, the communication module may not use Wi-Fi or Bluetooth Low Energy (BLE).

In one or more implementations, the system communication module of the example retail intelligent display system 300 may include wireless (e.g., Wireless Fidelity WI-FI, hotspot, etc.) and/or wired (e.g., POE, routers, hubs, splitters, etc.) components for data communication between the modules of the example retail intelligent display system 300.

In one or more implementations, the camera module of the example retail intelligent display system 300 may include a retail intelligent monitoring system. In one or more implementations, the retail intelligent monitoring system may include a merchandise display camera (e.g., 218A in FIG. 2), a merchandise scanning camera (e.g., 218B in FIG. 2), and an activity tracking camera (e.g., 218C in FIG. 2). In one or more implementations, the retail intelligent monitoring system may include a single camera with an image sensor and multiple lens in data communication with the retail intelligent display system 300. The camera module may be readily attachable to and removable from store fixtures. In some implementations, the camera module may be vandal proof, scratch resistant, only can be removed by special designed tool. In some implementations, the camera module may include both cameras that are readily attachable to and removable from store fixtures and other cameras that are vandal proof, scratch resistant, only can be removed by special designed tool. In some implementations, the camera module may include cameras connected to the store fixtures with special connector where the store fixtures will have the base for connector.

The modules of the example retail intelligent display system 300 may not be limited to the examples provided above to dynamically allow pricing and other information related to at least one article of merchandise be displayed on the at least one electronic display.

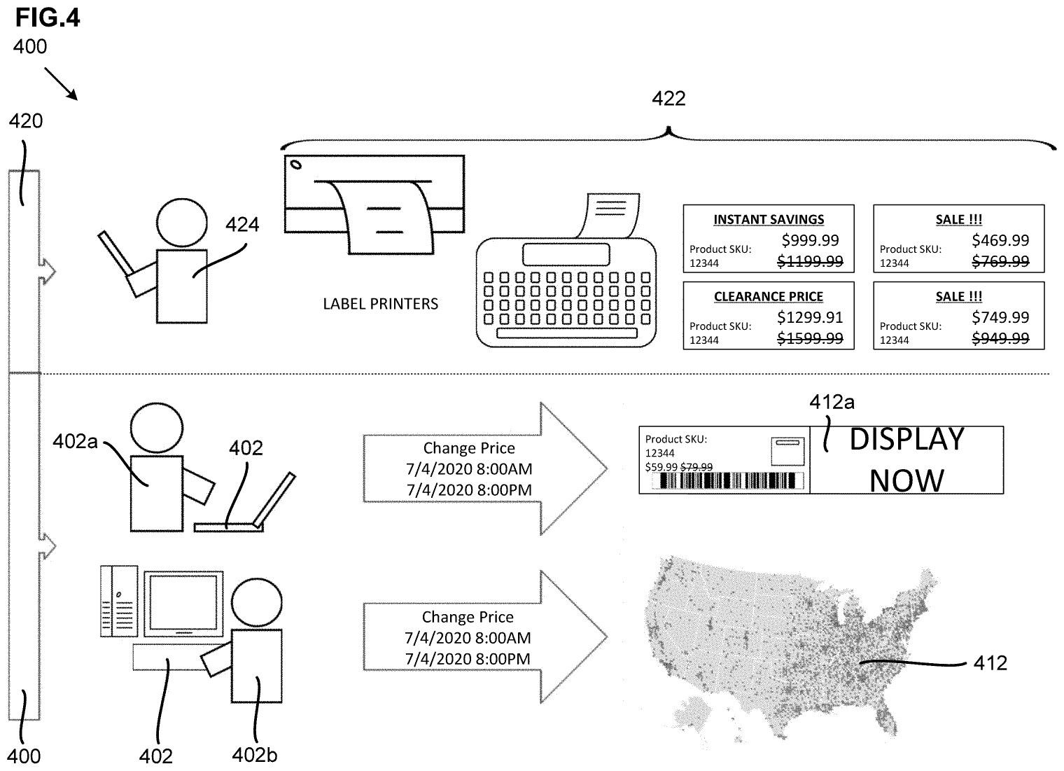

FIG. 4 is a schematic diagram illustrating a traditional price display system and an example retail intelligent display system 400 in accordance with an implementation of the present disclosure. In FIG. 4, the traditional pricing display system 420 includes price tags (e.g., printed paper or plastic tags, labels, etc.) 422 that are printed and displayed on store fixtures with approval from store management 424, for example, a store manager and/or a merchandiser from headquarters. With the traditional pricing display system 420, hundreds to thousands of tags may be printed based on an approved set pricing for all merchandises in at least one store. In a brick and mortar store, the number, and the costs, of printed tags may be manageable, however, in the wholesale-based warehouse stores, management of the pure number of printed labels alone could be a great challenge. Moreover, with high fluctuation in market pricing or simply incorrect price tags due to errors, management of printed labels poses even a greater challenge.

In one or more implementations of the present disclosure, the example retail intelligent display system 400 may include a plurality of electronic displays 412 in all stores that utilize the retail intelligent display system 400 (including at least one electronic display 412a), and one or more terminal devices 402. In one or more implementations, the plurality of electronic displays 412 and the at least one electronic display 412a may be similar to the electronic display 112 in FIG. 1, the electronic displays 212A, 212B in FIG. 2, and the display module in FIG. 3, thus details of the electronic displays in FIG. 4 are omitted for brevity.

In one or more implementations, the at least one electronic display 412a and the plurality of electronic displays 412 may be a physical electronic display in a store or an electronic copy replicating contents on the at least one electronic display 412a that is displayed on a terminal device 402 and operated by store management, for example, a corporate/headquarter pricing manager 402a or a branch store manager 402b. The terminal device 402 or a network device (not explicitly shown) may compare pricing information of at least one article of merchandise with pricing information from one or more competitor sources and update the pricing information of the at least one article of merchandise based on the pricing information from the one or more competitor sources, and the at least one electronic display 412a and/or the plurality of electronic displays 412 in all stores may display at least one updated pricing information and other comparable pricing information of the at least one article of merchandise simultaneously in real time. In some implementations, the at least one electronic display 412a and/or the plurality of electronic displays 412 in all stores may display updated pricing information and other pricing information at different time periods.

In some implementations with reference to FIG. 4, the corporate/headquarter pricing manager 402a may manually, or the terminal device 402 may automatically (e.g., via predetermined instructions executable by a processor of the terminal device 402 or the network device), compare pricing information of at least one article of merchandise with pricing information from one or more competitor sources. The pricing manager 402a may manually, or the terminal device 402 may automatically, update the pricing information of the at least one article of merchandise based on the pricing information from the one or more competitor sources for the at least one merchandise. The corporate/headquarter pricing manager 402a may further manually (e.g., accept a managerial approval request, etc.), or the terminal device 402 may automatically (e.g., via predetermined instructions executable by a processor of the terminal device 402 or the network device, etc.), approve and set at least one of the updated pricing information and other comparable pricing information of the at least one article of merchandise such that the at least one electronic display 412a may display the updated pricing information and other comparable pricing information of the at least one article of merchandise.

After the corporate/headquarter pricing manager 402a approves and sets the updated pricing information and other comparable pricing information of the at least one article of merchandise, the corporate/headquarter pricing manager 402a and/or a branch store manager 402b (or all branch managers in all branches) may manually allow, or the terminal device 402 may automatically, display in real time the updated and approved pricing information and other comparable pricing information of the at least one article of merchandise on the plurality of electronic displays 412 in all stores (substantially) in-synchronization (in-sync) with the electronic display 412a operated by the corporate/headquarter pricing manager 402a.

In some implementations, the manual (e.g., accepting a managerial approval request, etc.) or automatic (e.g., via predetermined instructions executable by a processor of the terminal device 402 or the network device, etc.) approval of the at least one of the updated pricing information and other comparable pricing information of the at least one article of merchandise may be performed before the manual or automatic updates of the pricing information of the at least one article of merchandise based on the pricing information from the one or more competitor sources for the at least one merchandise and manual or automatic display of the updated pricing information on the electronic displays 412.

In some implementations, displaying the updated and approved pricing information and other comparable pricing information of the at least one article of merchandise on the plurality of electronic displays 412 need not be in-sync with the electronic display 412a controlled by the corporate/headquarter pricing manager 402a, and the displayed pricing information and other comparable pricing information of the at least one article of merchandise on the plurality of electronic displays 412 need not be the same as the displayed pricing information and other comparable pricing information on the electronic display 412a controlled by the corporate/headquarter pricing manager 402a. In other words, the branch store manager 402b may approve and set its own pricing information and other comparable pricing information of any merchandise to be displayed on at least one electronic display 412a of a store.

In one or more implementations, the entity/people/person ultimately approving final pricing information or determining whether to display the final pricing information and other comparable pricing information on at least one electronic display 412a may not be limited to the examples provided herein. The example retail intelligent display system 400 may dynamically update merchandise pricing and improve retail management and customer experience.

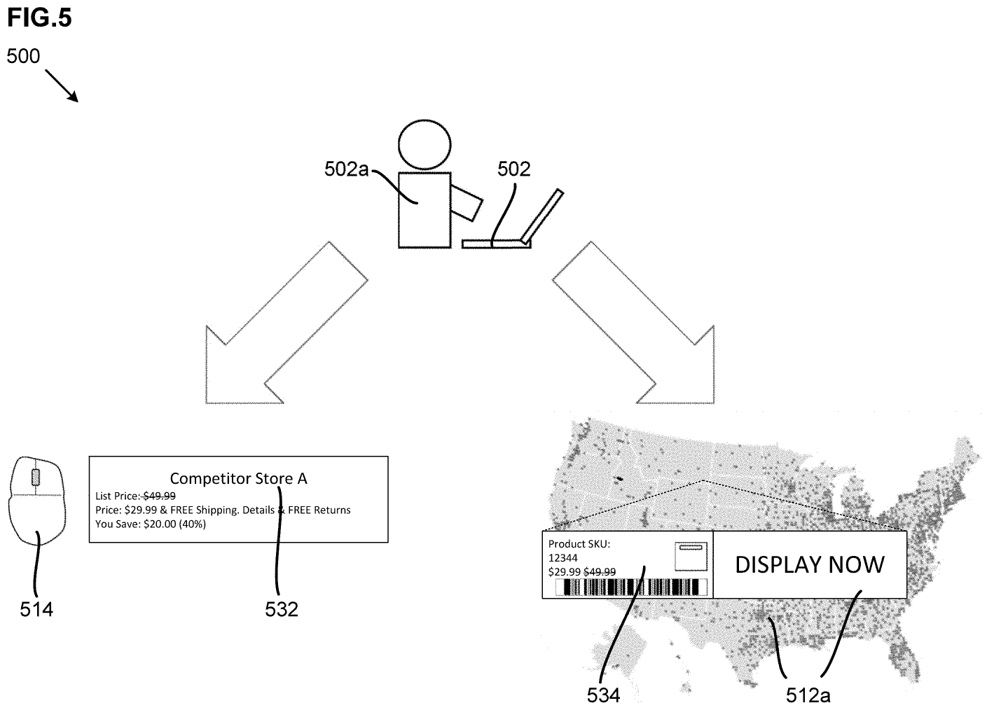

FIG. 5 is a schematic diagram further illustrating the example retail intelligent display system of the present disclosure in FIG. 4. The example retail intelligent display system 500 in FIG. 5 further illustrates the example retail intelligent display system 400 in FIG. 4. In one or more implementations, a plurality of electronic displays 512a of the intelligent display system 500 in FIG. 5 may be substantially similar to the electronic display 112 in FIG. 1, the electronic displays 212A, 212B in FIG. 2, the display module in FIG. 3, and the plurality of electronic displays 412, 412a in FIG. 4, thus details of the electronic displays 512a in FIG. 5 are omitted for brevity. A terminal device 502 in FIG. 5 may be similar to the terminal device 102 in FIG. 1 and the terminal devices 402 in FIG. 4, thus details of the terminal device 502 in FIG. 5 are omitted for brevity.

In one or more implementations, the example retail intelligent display system 500 may include a plurality of electronic displays 512a in one or more stores that utilize the retail intelligent display system 500 and a terminal device 502 operated by store management 502a, for example, a corporate/headquarter pricing manager or a branch store manager. The plurality of electronic displays 512a in one or more stores may be physical electronic displays in the one or more stores or an electronic replicate of contents displayed on the electronic displays 512a and on the terminal device 502 such that the store management 502a may control merchandise pricing. For example, the terminal device 502 or a network device (not explicitly shown) may compare pricing information of at least one article of merchandise with pricing information from one or more competitor sources and update the pricing information of the at least one article of merchandise based on the pricing information from the one or more competitor sources, and the plurality of electronic displays 512a in all stores may display at least one updated pricing information and other comparable pricing information of the at least one article of merchandise.

In some implementations with reference to FIG. 5, the store management 502a may manually or the terminal device 502 may automatically (e.g., via predetermined instructions executable by a processor of the terminal device 502 or the network device) compare pricing information of at least one article of merchandise 514 (e.g., a computer mouse) in one or more stores with pricing information of the merchandise 514 from one or more competitor sources 532 and manually or automatically update the pricing information of the merchandise 514 in one or more stores based on the pricing information of the merchandise 514 from the one or more competitor sources 532. The store management 502a may further manually or the terminal device 502 may automatically (e.g., via predetermined instructions executable by a processor of the terminal device 502 or the network device) approve and set at least one of updated pricing information 534 and other comparable pricing information of the merchandise 514 such that the electronic displays 512a in one or more stores may display the updated pricing information 534 and other comparable pricing information of the merchandise 514.

In some implementations, the manual (e.g., accepting a managerial approval request, etc.) or automatic (e.g., via predetermined instructions executable by a processor of the terminal device 502 or the network device, etc.) approval of the at least one of the updated pricing information 534 and other comparable pricing information of the at least one article of merchandise 514 may be performed before the manual or automatic updates of the pricing information of the at least one article of merchandise 514 based on the pricing information from the one or more competitor sources 532 for the at least one merchandise 514 and manual or automatic display of the updated pricing information 534 on the electronic displays 512a. The example retail intelligent display system 500 may dynamically update merchandise pricing and improve retail management and customer experience.

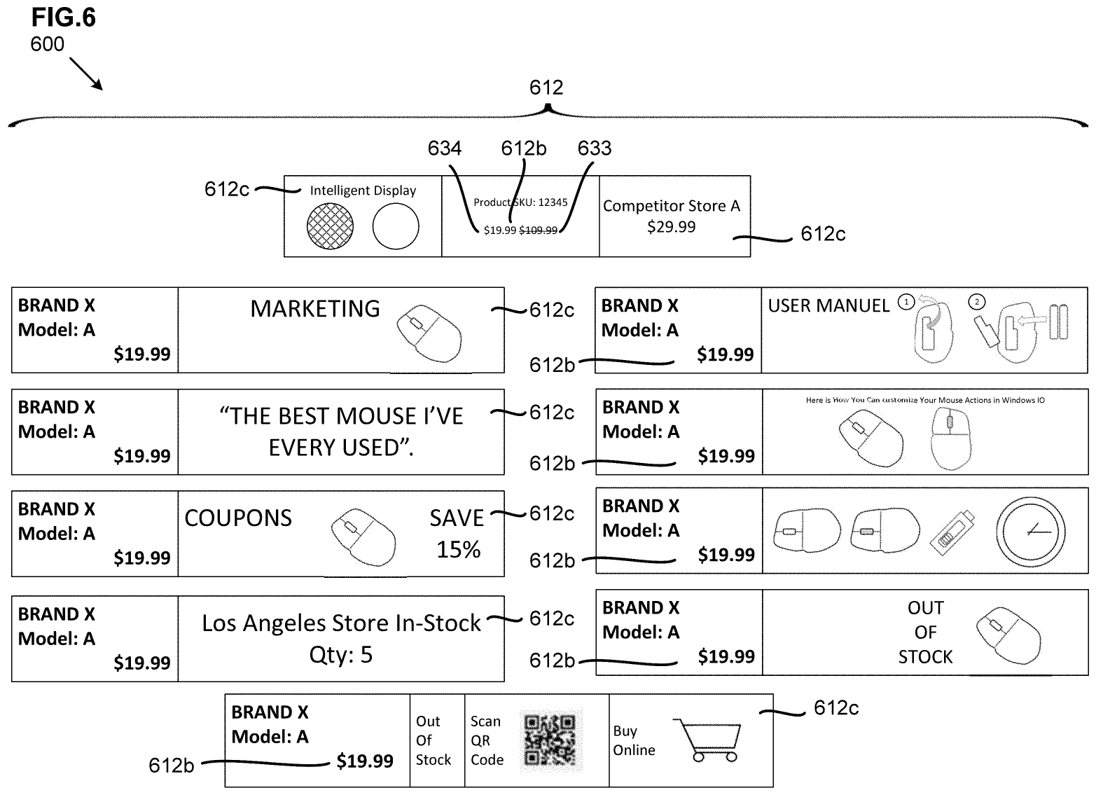

FIG. 6 is a schematic diagram of a plurality of displayable contents displayed on an electronic display of an example retail intelligent display system 600 in a retail environment in accordance with an implementation of the present disclosure. The example retail intelligent display system 600 may include at least one electronic display 612 displaying a plurality of displayable contents. In one or more implementations, the example retail intelligent display system 600 may also include (not shown in the figure) a terminal device, a network device, a routing device, and a data or power connector as shown in the retail intelligent display system 100 in FIG. 1, and the electronic display 112 in FIG. 1, electronic displays 212A, 212B in FIG. 2, display module in FIG. 3, electronic displays 412a, 412 in FIG. 4, and electronic displays 512a in FIG. 5.

In one or more implementations with reference to FIG. 6, the at least one electronic display 612 may display the plurality of displayable contents including pricing information 612b of at least one article of merchandise and related information 612c of the at least one article of merchandise (e.g., a computer mouse). The pricing information 612b may, for example, include any pricing information such as an original pricing information 633 and an updated pricing information 634 of the mouse. The related information 612c associated with the at least one article of merchandise may include at least one of pricing information from one or more competitor sources (e.g., pricing from competitor store A 532 of the mouse in example intelligent display system 500 of FIG. 5), marketing content (e.g. electronic brochure, flyer, etc.), advertising content (e.g., quote from a professional mouse reviewer, etc.), promotional content (e.g., coupons, promotional codes, on-sale pricing, cross-promotional sales, Online to Offline (020) campaigns including one or more in-store lottery or treasure hunts, etc.), inventory content (e.g., the number of available mouse for sale in a certain store location, out of stock, backordered, available inventory of the mouse in the nearest store or on any e-commerce portal, etc.), manuals (e.g., mouse assembly instructions, safety tips, quick start guides, warranty, etc.), and miscellaneous content (e.g., how to customize a button's function on a mouse, mouse color selection, other merchandise that are also bought together with the mouse by other customers, a store announcement message, etc.) displayable on the electronic display 612.

In some implementations, the electronic display 612 of the example retail intelligent display system 600 may include a touch-sensing and/or a gesture-sensing display that displays the related information 612c associated with the at least one article of merchandise in an interactive platform (e.g., a graphic user interface, GUI) such that the electronic display 612 may provide an interactive experience while providing merchandise related information to shoppers/customers. For example, with reference to FIG. 6, the related information 612c associated with the at least one article of merchandise (e.g., the computer mouse) may be a QR code that the shoppers'/customers' smart phones may be interactive with to check the available stock of the mouse in store or complete instant purchase of the article of merchandise.

In some implementations, the retail intelligent display system 600 may also include at least one of a light source, a speaker, a microphone, and a global positioning system (GPS) tracker in addition to the electronic display 612. For example, the shoppers/customers may check a technical review of a merchandise (e.g., a computer mouse of brand X) displayed on the electronic display 612, choose the desired color of the brand X mouse on the electronic display 612, confirm whether the desired color brand X mouse is in stock in a certain store location (e.g., Los Angeles Store in FIG. 6) on the electronic display 612, obtain a discount coupon of 15% from the certain store on the electronic display 612, obtain the geolocation (e.g., an address of a certain store, a specific aisle, a specific store fixture, etc.) of the brand X mouse in a certain store via GPS tracking, and locate the geolocation of the brand X mouse through a visual signal (e.g., the electronic display 612 blinking red color, or a green blinking LED light, etc.) on the electronic display 612 such that the shoppers/customers' may easily pinpoint the location of the brand X mouse. The shoppers'/customers' smart phones may also scan a QR code displayed on the electronic display 612 to complete transaction of the brand X mouse located on a store fixture of the certain store.

In one or more implementations, after the electronic display 612 of the example retail intelligent display system 600 display at least one of the marketing content, advertising content, and promotional content, the retail intelligent display system 600 may further store information, in a non-transitory machine-readable memory, regarding a number of times and time length that the at least one of the marketing content, the promotional content, and the advertising content are displayed on the electronic display 612. The example retail intelligent display system 600 may further provide the information regarding the number of times and the time length that the at least one of the marketing content, the promotional content, and the advertising content are displayed on the electronic display 612 to a marking, promotional or advertising entity (e.g., an in-house and/or a third party marketing company, promotional company, and/or an advertising company) associated with the at least one of the marketing content, the promotional content, and the advertising content.

In some implementations, the electronic display 612 may dynamically display promotional contents, such as coupons and/or on-sale pricing, such that shoppers/customers may never miss an on-sale sign or an extended on-sale period. The implementations of the example retail intelligent display system 600 may not be limited to the examples provided above. In some implementations, the electronic display 612 may dynamically display promotional contents, such as promotional codes (e.g., one time QR codes, no limit alphanumeric codes, etc.), for shopper/customers' interactions which may provide instant incentives to complete a sale. In some implementations, the electronic display 612 may display at least one of the marketing content, the promotional content, and the advertising content before, after, or at a predetermined time such that the electronic display 612 may automatically display at least one of the marketing, promotional, and advertising content (e.g., shorts and short-sleeve t-shirts, etc.) at a suitable time (e.g., Summer, etc.).

In some implementations, the electronic display 612 of the example retail intelligent display system 600 may display a cross-promotional sales content (related information 612c not explicitly shown) of an article of merchandise (e.g., the computer mouse, etc.). For example, before a shopper/customer completes an order of the brand X mouse, the electronic display 612 may further display a cross promotion prompt, such as ergonomics and health benefits of using a mouse and keyboard pad combination. The prompt may include visual data (e.g., video, images, etc.) illustrating a brand X mouse that is located in aisle 6, shelf 3A of the store and a brand Y keyboard pad located in an aisle and shelf immediately adjacent to the brand X mouse since a brand X keyboard is not currently available in store for a single transaction with the brand X mouse.

The implementations of the example retail intelligent display system 600 may not be limited to the examples provided above. The example retail intelligent display system 600 may dynamically update and display pricing information 612b and related information 612c regarding at least one article of merchandise to improve retail management, customer experience, and marketing/promotional/advertising content dissemination in connection with the at least one article of merchandise.

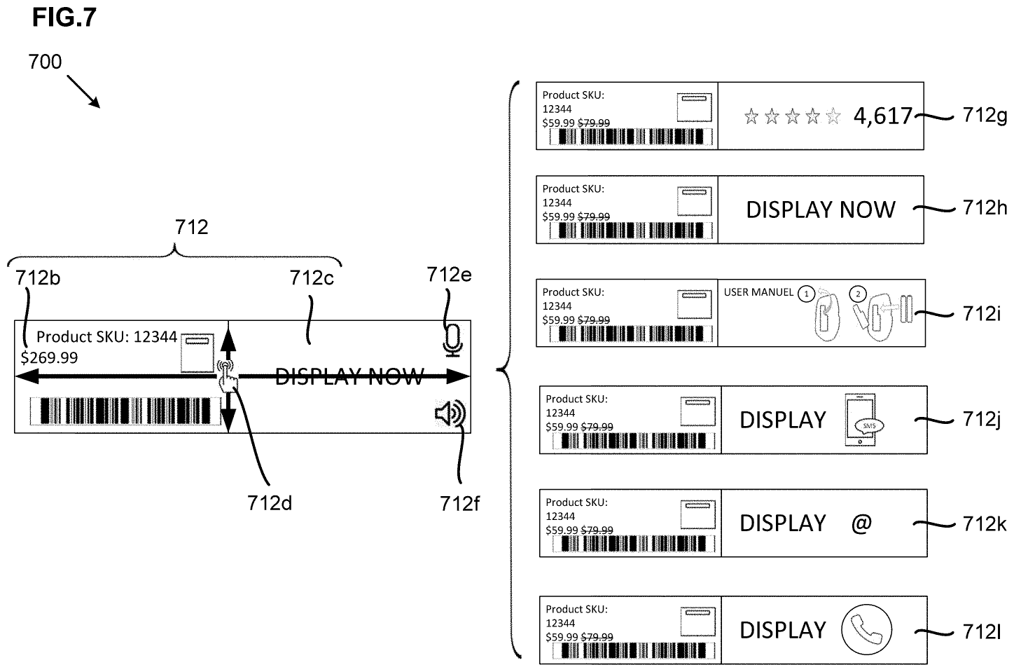

FIG. 7 is a schematic diagram further illustrating the example retail intelligent display system of the present disclosure in FIG. 6. In one or more implementations, the example retail intelligent display system 700 may include at least one electronic display 712 displaying a plurality of displayable contents similar to the displayable contents described above in the example retail intelligent display system 600. The electronic display 712 of the example retail intelligent display system 700 may be substantially similar to the electronic display 612 in FIG. 6, electronic displays 512a in FIG. 5, electronic displays 412, 412a in FIG. 4, display module in FIG. 3, electronic displays 212A, 212B in FIG. 2, and electronic display 112 in FIG. 1, thus details of the electronic display 712 is omitted for brevity. In one or more implementations, the example retail intelligent display system 700 may also include (not shown in the figure) a terminal device, a network device, a routing device, and a data or power connector as shown in the retail intelligent display system 100 in FIG. 1.

In one or more implementations with reference to FIG. 7, the electronic display 712 may display a plurality of displayable contents including pricing information 712b of at least one article of merchandise and related information 712c of the at least one article of merchandise. The pricing information 712b may include any pricing information (e.g., original pricing information 633 and an updated pricing information 634 in FIG. 6, etc.). The related information 712c associated with the at least one article of merchandise may include at least one of related information 612c in the example retail intelligent display system 600, and other information, such as interactive on-screen button 712d (e.g., a microphone button 712e, a speaker button 712f, a review button 712g, a display button 712h, a manual button 712i, a messaging button 712j, an email button 712k, and a call button 712l, etc.) associated with the merchandise.

In one or more implementations of the present disclosure, the electronic display 712 of the retail intelligent display system 700 may include a touch-sensing and/or a gesture-sensing display that displays the related information 712c associated with the at least one article of merchandise in an interactive platform (e.g., a graphic user interface, GUI), such that the electronic display 712 may provide an interactive experience while providing merchandise related information to shoppers/customers in a store. In one or more implementations, the retail intelligent display system 700 may also include a speaker and a microphone in addition to the electronic display 712 to provide interactive experience to shoppers/customers. For example, a speaker and a microphone (not shown) may be installed in close proximity to the store fixture where the merchandise is located and the electronic display 712 may display the related information 712c, such as the speaker button 712f and the microphone button 712e (as shown in FIG. 7) associated with the merchandise. In some implementations, the speaker and microphone may be components of the electronic display 712, In some implementations, the shoppers/customers may interact with the microphone button 712e, the microphone may receive audio input (e.g., speech, etc.) from shoppers/customers, and the electronic display 712 may display content based on the input from the shoppers/customers.

The shoppers/customers may request for a sales associate's assistance through the microphone, the electronic display 712 may display a message indicating a sales associate is on his/her way while the speaker announces that “a sales associate is on his/her way”. The shoppers/customers may interact with the speaker button 712f to mute or unmute all sounds from the speaker. In some implementations, different announcements (e.g., a price change, a promotion, etc.) may be made through the speaker (e.g., upon sensing that a customer is near the display). The electronic display 712 of the retail intelligent display system 700 may also include the following displayable contents to provide an interactive experience to the shoppers/customers. In some implementations, the electronic display 712 may display the related information 712c, such as the review button 712g, where the shoppers/customers may interact with the review button 712g to view the number of reviews and contents of the reviews regarding the merchandise of interest to the shoppers/customers.

In some implementations, the electronic display 712 may display the related information 712c, such as the display button 712h, where the shoppers/customers may interact with the display button 712h to view videos or images (e.g., marketing content, etc.) regarding the merchandise of interest to the shoppers/customers. In some implementations, the electronic display 712 may display the related information 712c, such as the manual button 712i, where the shoppers/customers may interact with the manual button 712i to view assembly or operational instructions regarding the merchandise of interest.

In some implementations, the electronic display 712 may display the related information 712c such as the messaging button 712j, where the shoppers/customers may interact with the messaging button 712j to communicate with a merchandise specialist directly from the merchandise's manufacturer via texting regarding the merchandise of interest. In some implementations, the electronic display 712 may display the related information 712c, such as the email button 712k, where the shoppers/customers may interact with the email button 712k to email a merchandise specialist from the merchandise's manufacturer regarding the merchandise of interest. In some implementations, the electronic display 712 may display the related information 712c, such as the call button 712l, where the shoppers/customers may interact with the call button 712l to communicate with a merchandise specialist from the merchandise's manufacturer via a call (e.g., voice or video call) regarding the merchandise of interest.

The implementations of the example retail intelligent display system 700 may not be limited to the examples provided above to allow more interactive opportunities between shoppers/customers and retail stores or manufactures with or without store associate's assistance, more enhanced shopping experiences, increase sales, and lower labor costs. The example retail intelligent display system 700 may dynamically update and display pricing information 712b and related information 712c regarding at least one article of merchandise to improve retail management, customer experience, and marketing/promotional/advertising content dissemination in connection with the at least one article of merchandise.

In one or more implementations, the electronic displays of the example retail intelligent display systems in the present disclosure may enter a power saving mode after a predetermined time period. In some implementations, the electronic display of the retail intelligent display system may enter a power saving mode when the retail intelligent monitoring system detects no customer activity or presence or out-of-store hours.

In one or more implementations of the present disclosure, the example retail intelligent display system 200 in FIG. 2, the example system 300 in FIG. 3, the example system 400 in FIG. 4, the example system 500 in FIG. 5, the example system 600 in FIG. 6, and the example system 700 in FIG. 7 may communicatively couple, via a network device or directly, to the retail intelligent monitoring system (e.g., 218 in FIG. 2). The retail intelligent monitoring system may capture visual data of at least one article of merchandise on at least one store fixture and/or visual data of the customers'/shoppers' behaviors in connection with the at least one article of merchandise on the at least one store fixture.

In some implementations, the retail intelligent monitoring system may capture visual data indicating the merchandise is out of stock and communicate to the retail intelligent display system that the merchandise is out of stock. The electronic display of the retail intelligent display system may display an out of stock message and at least one alternative source for purchasing the merchandise, for example, via the network device. In some implementations, the retail intelligent display system may display other inventory information related to a merchandise (e.g., fully stocked, or low in stock in a store) from the retail intelligent monitoring system and may display further inventory information (e.g., stock quantity in other stores or a store website), such that the shopper may determine whether to order the corresponding merchandise (e.g., order at another store or order online via a mobile device/terminal). In some implementations, upon scanning the information related to the merchandise (e.g., a customer using a camera of a smartphone to scan a QR code that is associated with the merchandise and is displayed on an electronic display), the retail intelligent monitoring system may provide the information related to the merchandise on the customer's phone, such that the customer may easily order the merchandise on the phone.

In some implementations, the activity tracking camera of the retail intelligent monitoring system may capture visual data tracking a shopper's facial (e.g., eye) movements toward a specific merchandise of interest and other facial related information (e.g., the length of time of the eye movements) and may communicate the visual data to the retail intelligent display system, such that the electronic display may display, for example, pricing information of the specific merchandise of interest in the store in comparison with pricing information from a competitor store. The merchandise display camera or the merchandise scanning camera of the retail intelligent monitoring system may capture visual data determining whether the specific merchandise of interest has been removed from a store fixture by a shopper. The retail intelligent monitoring system may determine whether a transaction is completed for the merchandise of interest by a customer (a patron that was previously the shopper). As such, a sales conversion ratio (e.g., indicates a rate/ratio at which shopped items convert to completed transactions or sales) may improve.

In some implementations, the activity tracking camera of the retail intelligent monitoring system may capture visual data tracking a shopper's facial (e.g., eye) movements toward a specific merchandise of interest, and may communicate with the retail intelligent display system after analyzing the captured data, such that the electronic display performs a particular act. For example, after determining that a customer has stared at a particular merchandise for a particular amount of time, the retail intelligent monitoring system may communicate with the electronic display, such that the electronic display may display, for example, advertising, marketing, or promotional contents associated with the particular merchandise.

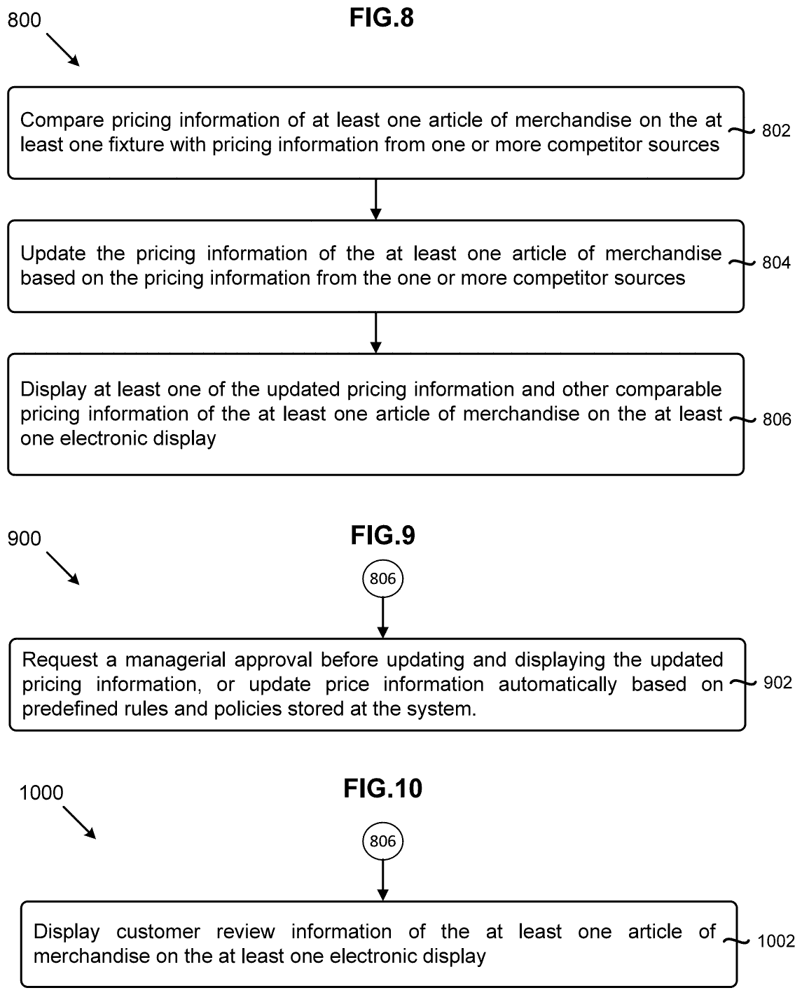

FIG. 8 is a flowchart diagram illustrating an example method performed by a retail intelligent display system in accordance with example implementations of the present disclosure. The example implementation 800 of the method of the retail intelligent display system in FIG. 8 may include one or more electronic display, a terminal device, and a network device as described in any of the example retail intelligent display system 100 in FIG. 1, the example system 200 in FIG. 2, the example system 300 in FIG. 3, the example system 400 in FIG. 4, the example system 500 in FIG. 5, the example system 600 in FIG. 6, and the example system 700 in FIG. 7, thus details of the retail intelligent display system of the present disclosure are omitted for brevity.

Referring to FIG. 8, in action 802, the retail intelligent display system may compare pricing information of at least one article of merchandise on the at least one store fixture with pricing information from one or more competitor sources.

In action 804, the retail intelligent display system may further update the pricing information of the at least one article of merchandise based on the pricing information from the one or more competitor sources.

In action 806, the retail intelligent display system may further display at least one of the updated pricing information and other comparable pricing information of the at least one article of merchandise on the at least one electronic display in each of the plurality of stores.

FIG. 9 is a flowchart diagram further illustrating an example implementation of the method of the retail intelligent display system in FIG. 8. The example implementation 900 of the method of the retail intelligent display system in FIG. 9 may include one or more electronic display, a terminal device, and a network device as described in any of the example retail intelligent display system 100 in FIG. 1, the example system 200 in FIG. 2, the example system 300 in FIG. 3, the example system 400 in FIG. 4, the example system 500 in FIG. 5, the example system 600 in FIG. 6, and the example system 700 in FIG. 7, thus details of the retail intelligent display system of the present disclosure are omitted for brevity.

Referring to FIG. 9, in action 902, after the retail intelligent display system display at least one of the updated pricing information and other comparable pricing information of the at least one article of merchandise on the at least one electronic display in each of the plurality of stores in action 806 of FIG. 8, the retail intelligent display system may further request a managerial approval before updating and displaying the updated pricing information, or update price information automatically based on predefined rules and policies stored at the system.

FIG. 10 is a flowchart diagram further illustrating an example implementation of the method of the retail intelligent display system in FIG. 8. The example implementation 1000 of the method of the retail intelligent display system in FIG. 10 may include one or more electronic display, a terminal device, and a network device as described in any of the example retail intelligent display system 100 in FIG. 1, the example system 200 in FIG. 2, the example system 300 in FIG. 3, the example system 400 in FIG. 4, the example system 500 in FIG. 5, the example system 600 in FIG. 6, and the example system 700 in FIG. 7, thus details of the retail intelligent display system of the present disclosure are omitted for brevity.

Referring to FIG. 10, in action 1002, after the retail intelligent display system display at least one of the updated pricing information and other comparable pricing information of the at least one article of merchandise on the at least one electronic display in each of the plurality of stores in action 806 of FIG. 8, the retail intelligent display system may further display customer review information of the at least one article of merchandise on the at least one electronic display.

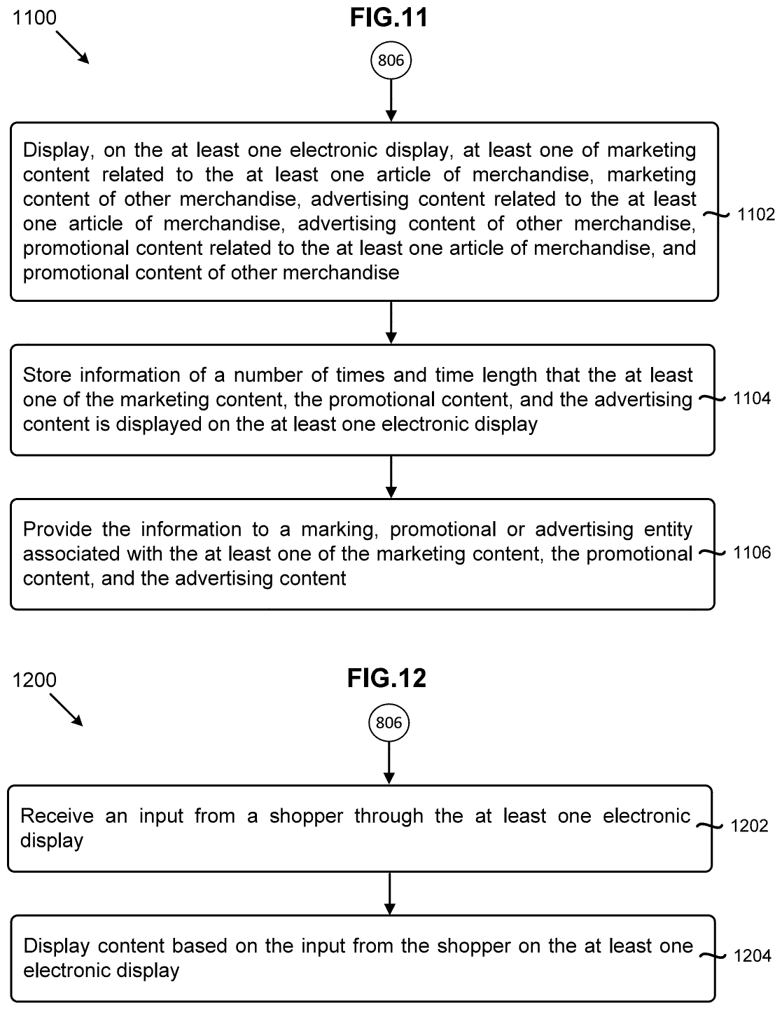

FIG. 11 is a flowchart diagram further illustrating an example implementation of the method of the retail intelligent display system in FIG. 8. The example implementation 1100 of the method of the retail intelligent display system in FIG. 11 may include one or more electronic display, a terminal device, and a network device as described in any of the example retail intelligent display system 100 in FIG. 1, the example system 200 in FIG. 2, the example system 300 in FIG. 3, the example system 400 in FIG. 4, the example system 500 in FIG. 5, the example system 600 in FIG. 6, and the example system 700 in FIG. 7, thus details of the retail intelligent display system of the present disclosure are omitted for brevity.

Referring to FIG. 11, in action 1102, after the retail intelligent display system display at least one of the updated pricing information and other comparable pricing information of the at least one article of merchandise on the at least one electronic display in each of the plurality of stores in action 806 of FIG. 8, the retail intelligent display system may further display, on the at least one electronic display, at least one of marketing content related to the at least one article of merchandise, marketing content of other merchandise, advertising content related to the at least one article of merchandise, advertising content of other merchandise, promotional content related to the at least one article of merchandise, and promotional content of other merchandise.

In action 1104, the retail intelligent display system may further store information of a number of times and time length that the at least one of the marketing content, the promotional content, and the advertising content is displayed on the at least one electronic display.

In action 1106, the retail intelligent display system may further provide the information to a marking, promotional or advertising entity associated with the at least one of the marketing content, the promotional content, and the advertising content.

FIG. 12 is a flowchart diagram further illustrating an example implementation of the method of the retail intelligent display system in FIG. 8. The example implementation 1200 of the method of the retail intelligent display system in FIG. 12 may include one or more electronic display, a terminal device, and a network device as described in any of the example retail intelligent display system 100 in FIG. 1, the example system 200 in FIG. 2, the example system 300 in FIG. 3, the example system 400 in FIG. 4, the example system 500 in FIG. 5, the example system 600 in FIG. 6, and the example system 700 in FIG. 7, thus details of the retail intelligent display system of the present disclosure are omitted for brevity.

Referring to FIG. 12, in action 1202, after the retail intelligent display system display at least one of the updated pricing information and other comparable pricing information of the at least one article of merchandise on the at least one electronic display in each of the plurality of stores in action 806 of FIG. 8, the retail intelligent display system may further receive an input from a shopper through the at least one electronic display.

In action 1204, the retail intelligent display system may further display content based on the input from the shopper on the at least one electronic display.

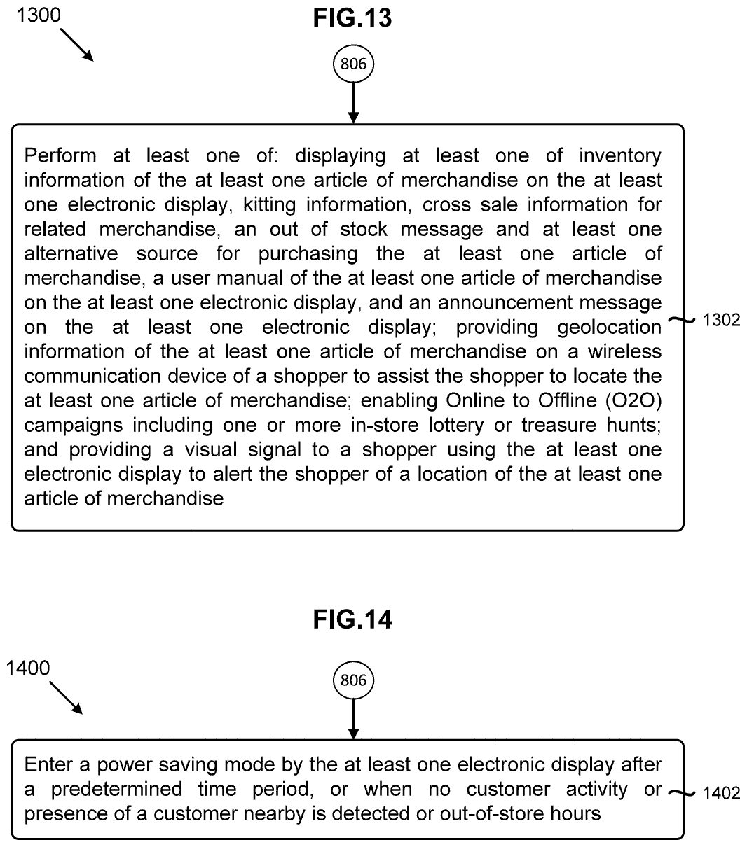

FIG. 13 is a flowchart diagram further illustrating an example implementation of the method of the retail intelligent display system in FIG. 8. The example implementation 1300 of the method of the retail intelligent display system in FIG. 13 may include one or more electronic display, a terminal device, and a network device as described in any of the example retail intelligent display system 100 in FIG. 1, the example system 200 in FIG. 2, the example system 300 in FIG. 3, the example system 400 in FIG. 4, the example system 500 in FIG. 5, the example system 600 in FIG. 6, and the example system 700 in FIG. 7, thus details of the retail intelligent display system of the present disclosure are omitted for brevity.

Referring to FIG. 13, in action 1302, after the retail intelligent display system display at least one of the updated pricing information and other comparable pricing information of the at least one article of merchandise on the at least one electronic display in each of the plurality of stores in action 806 of FIG. 8, the retail intelligent display system may further perform at least one of: displaying at least one of inventory information of the at least one article of merchandise on the at least one electronic display, kitting information, cross sale information for related merchandise, an out of stock message and at least one alternative source for purchasing the at least one article of merchandise, a user manual of the at least one article of merchandise on the at least one electronic display, and a store announcement message on the at least one electronic display; providing geolocation information of the at least one article of merchandise on a wireless communication device of a shopper to assist the shopper to locate the at least one article of merchandise; enabling Online to Offline (020) campaigns including one or more in-store lottery or treasure hunts; and providing a visual signal to a shopper using the at least one electronic display to alert the shopper of a location of the at least one article of merchandise.

FIG. 14 is a flowchart diagram further illustrating an example implementation of the method of the retail intelligent display system in FIG. 8. The example implementation 1400 of the method of the retail intelligent display system in FIG. 14 may include one or more electronic display, a terminal device, and a network device as described in any of the example retail intelligent display system 100 in FIG. 1, the example system 200 in FIG. 2, the example system 300 in FIG. 3, the example system 400 in FIG. 4, the example system 500 in FIG. 5, the example system 600 in FIG. 6, and the example system 700 in FIG. 7, thus details of the retail intelligent display system of the present disclosure are omitted for brevity.

Referring to FIG. 14, in action 1402, after the retail intelligent display system display at least one of the updated pricing information and other comparable pricing information of the at least one article of merchandise on the at least one electronic display in each of the plurality of stores in action 806 of FIG. 8, the retail intelligent display system may further enter a power saving mode by the at least one electronic display after a predetermined time period, or when no customer activity or presence is detected or out-of-store hours.

From the present disclosure, it can be seen that various techniques may be used for implementing the concepts described in the present disclosure without departing from the scope of those concepts. While the concepts have been described with specific reference to certain implementations, a person of ordinary skill in the art may recognize that changes may be made in form and detail without departing from the scope of those concepts.

As such, the described implementations are to be considered in all respects as illustrative and not restrictive. It should also be understood that the present disclosure is not limited to the particular implementations described but rather many rearrangements, modifications, and substitutions are possible without departing from the scope of the present disclosure.

What is claimed is:

1. A retail intelligent display system, comprising:
at least one fixture, the at least one fixture configured for placing at least one article of merchandise thereon;
at least one electronic display coupled to the at least one fixture; and
a network device comprising:
a communication module communicatively coupled to the at least one electronic display;
a processor communicatively coupled to the communication module and the at least one electronic display; and
a non-transitory machine-readable memory storing instructions that, when executed by the processor, cause the retail intelligent display system to:
compare pricing information of the at least one article of merchandise with pricing information from one or more competitor sources;
update the pricing information of the at least one article of merchandise based on the pricing information from the one or more competitor sources; and
display at least one of the updated pricing information and other comparable pricing information of the at least one article of merchandise on the at least one electronic display.

2. The retail intelligent display system of claim 1, wherein the non-transitory machine-readable memory stores additional instructions that, when executed by the processor, cause the retail intelligent display system to:
request a managerial approval before updating and displaying the updated pricing information, or update price information automatically based on predefined rules and policies stored at the system.

3. The retail intelligent display system of claim 1, wherein the one or more competitor sources include e-commerce competitors.

4. The retail intelligent display system of claim 1, wherein the non-transitory machine-readable memory stores additional instructions that, when executed by the processor, cause the retail intelligent display system to:
display customer review information of the at least one article of merchandise on the at least one electronic display.

5. The retail intelligent display system of claim 1, wherein the non-transitory machine-readable memory stores additional instructions that, when executed by the processor, cause the retail intelligent display system to perform at least one of:
displaying, on the at least one electronic display, at least one of:
marketing content related to the at least one article of merchandise;
marketing content of other merchandise;
advertising content related to the at least one article of merchandise;
advertising content of other merchandise;
promotional content related to the at least one article of merchandise; and
promotional content of other merchandise;
storing information of a number of times and time length that the at least one of the marketing content, the promotional content, and the advertising content is displayed on the at least one electronic display; and
providing the information to a marking, promotional or advertising entity associated with the at least one of the marketing content, the promotional content, and the advertising content.

6. The retail intelligent display system of claim 1, wherein the at least one electronic display is an interactive display that allows a shopper to interact with content regarding the at least one article of merchandise and displaying on the at least one electronic display.

7. The retail intelligent display system of claim 6, wherein the interactive display includes at least one of one or more touch sensors, gesture sensors, and microphones.

8. The retail intelligent display system of claim 1, wherein the non-transitory machine-readable memory stores additional instructions that, when executed by the processor, cause the retail intelligent display system to perform at least one of:
displaying at least one of:
inventory information of the at least one article of merchandise on the at least one electronic display;
kitting information;
cross sale information for related merchandise;
a user manual of the at least one article of merchandise on the at least one electronic display; and
an announcement message on the at least one electronic display;
providing geolocation information of the at least one article of merchandise on a wireless communication device of a shopper to assist the shopper to locate the at least one article of merchandise;
enabling Online to Offline (020) campaigns including one or more in-store lottery or treasure hunts; and
providing a visual signal to a shopper using the at least one electronic display to alert the shopper of a location of the at least one article of merchandise.

9. The retail intelligent display system of claim 8, wherein:
the network device is communicatively coupled to a retail intelligent monitoring system for monitoring the at least one article of merchandise on the at least one fixture; and
the network device is configured to cause the at least one electronic display to display an out of stock message and at least one alternative source for purchasing the at least one article of merchandise.

10. The retail intelligent display system of claim 1, wherein:
the network device is communicatively coupled to a retail intelligent monitoring system for monitoring the at least one article of merchandise on the at least one fixture; and
the at least one electronic display enters a power saving mode after a predetermined time period or when the retail intelligent monitoring system detects no customer activity or presence of a customer nearby or out-of-store hours.

11. The retail intelligent display system of claim 1, wherein the network device is coupled to a backend device.

12. A method for a retail intelligent display system including at least one electronic display installed on at least one fixture, the method comprising:
comparing pricing information of at least one article of merchandise on the at least one fixture with pricing information from one or more competitor sources;
updating the pricing information of the at least one article of merchandise based on the pricing information from the one or more competitor sources; and
displaying at least one of the updated pricing information and other comparable pricing information of the at least one article of merchandise on the at least one electronic display.

13. The method of claim 12, further comprising:
requesting a managerial approval before updating and displaying the updated pricing information, or update price information automatically based on predefined rules and policies stored at the system.

14. The method of claim 12, wherein the one or more competitor sources include e-commerce competitors.

15. The method of claim 12, further comprising:
displaying customer review information of the at least one article of merchandise on the at least one electronic display.

16. The method of claim 12, further comprising:
displaying, on the at least one electronic display, at least one of:
marketing content related to the at least one article of merchandise;
marketing content of other merchandise;
advertising content related to the at least one article of merchandise;
advertising content of other merchandise;
promotional content related to the at least one article of merchandise; and
promotional content of other merchandise;
storing information of a number of times and time length that the at least one of the marketing content, the promotional content, and the advertising content is displayed on the at least one electronic display; and
providing the information to a marking, promotional or advertising entity associated with the at least one of the marketing content, the promotional content, and the advertising content.

17. The method of claim 12, further comprising:
receiving an input from a shopper through the at least one electronic display; and
displaying content based on the input from the shopper on the at least one electronic display.

18. The method of claim 12, wherein the at least one electronic display includes at least one of one or more touch sensors, gesture sensors, and microphones.

19. The method of claim 12, further comprising performing at least one of:
displaying at least one of:
inventory information of the at least one article of merchandise on the at least one electronic display;
kitting information;
cross sale information for related merchandise;
an out of stock message and at least one alternative source for purchasing the at least one article of merchandise;
a user manual of the at least one article of merchandise on the at least one electronic display; and
an announcement message on the at least one electronic display;
providing geolocation information of the at least one article of merchandise on a wireless communication device of a shopper to assist the shopper to locate the at least one article of merchandise;
enabling Online to Offline (020) campaigns including one or more in-store lottery or treasure hunts; and
providing a visual signal to a shopper using the at least one electronic display to alert the shopper of a location of the at least one article of merchandise.

20. The method of claim 12, further comprising:
entering a power saving mode by the at least one electronic display:
after a predetermined time period; or
when no customer activity or presence of a customer nearby is detected or out-of-store hours.
